(19) United States
(12) Patent Application Publication
(10) Pub. No.: US 2005/0000549 A1
(43) Pub. Date: Jan. 6, 2005

(54) Wafer processing using gaseous antistatic agent during drying phase to control charge build-up

(76) Inventors: James R. Oikari, Sauk Rapids, MN (US); Tracy A. Gast, Waconia, MN (US); Luke S. Chang, Chaska, MN (US)

Correspondence Address: Kevin J. Hubbard;Kagan Binder, PLLC, Maple Island Building, Suite 200, 221 Main Street North, Stillwater, MN, 55082, US

(21) Appl. No.: 10/613,931

(22) Filed: Jul. 3, 2003

(51) Int. Cl. B08B 3/02

(52) U.S. Cl. 134/25.4; 134/26; 134/30; 134/37

(57) ABSTRACT

Described are methods of processing one or more semiconductor wafers wherein the one or more wafers are processed in the presence of a gaseous antistatic agent. The method generally comprises performing one or more chemical treatment, rinsing, and/or drying steps in the presence of a gaseous antistatic agent. Preferably, a gaseous antistatic agent is present during at least a portion of a drying step and more preferably, during at least a portion of both a rinsing step and a drying step. In one preferred embodiment, the gaseous antistatic agent comprises carbon dioxide.

### FIELD OF THE INVENTION

The present invention relates generally to a method of processing one or more semiconductor wafers in the presence of a gaseous antistatic agent such as carbon dioxide gas. More particularly, the present invention relates to a process including drying, or both rinsing and drying, one or more semiconductor wafers in the presence of a gaseous antistatic agent.

### BACKGROUND OF THE INVENTION

Industry spends significant resources in the processing of a variety of commercially important wafers. Commercial wafers that can require surface processing include, to name a few, those involved in the manufacture of microelectronic devices such as integrated semiconductor circuits (e.g., semiconductor wafers), display screens comprising liquid crystals, electric circuits on boards of synthetic material (circuit boards), and other commercially significant materials and products. These devices can be fabricated according to a series of treatments, each including one or a number of steps for modifying, adding to, or otherwise processing a wafer. Methods for processing these and other wafers can include steps of chemical processing, cleaning, rinsing, drying, and/or otherwise.

With respect to the processing of microelectronic devices in particular, these can require one or more of chemical, rinsing, and drying, steps, often in a contaminant-free environment. Typical conventional processing equipment includes the capability of exposing one or a number of wafers to different processing fluids (e.g., liquids and/or gases) in one or more chambers, vessels, or the like, to accomplish one and preferably a series of such wafer processing operations. These machines can perform a series of various chemical steps, followed by rinsing and drying, to provide a highly contaminant-free wafer(s).

This type of processing generally involves application of a suitable treatment chemical to a wafer surface, e.g., a gaseous or liquid chemical solution or agent. The chemical agent must subsequently be removed. This is often accomplished by a separate rinsing operation, which uses a rinsing fluid such as deionized water (with one or more adjuvants) to dilute and ultimately wash away the previously-applied materials. Different types of machines accomplish the rinse operation in different fashions. Some rinse by immersion of the wafer(s). Some rinse by spraying fluids onto a wafer surface(s). Some machines include the ability to heat wafers or expose wafers to particular environments, some rinse by flowing a liquid past a wafer(s), and some include the ability to remove liquids with centrifugal force by spinning or rotating the wafer(s) on a turntable or carousel, either about their own axis or about a common axis. Some use combinations of these. Exemplary machines that rinse by spraying fluids on wafer surfaces, also known as spray processor type machines, are described in U.S. Pat. Nos. 6,406,551 and 6,488,272 to Nelson et al., which are fully incorporated herein by reference. Spray processor type machines are available from FSI International, Inc. of Chaska, Minn., e.g., under one or more of the trade designations MERCURY® or ZETA®.

After rinsing, the rinsing fluid is usually removed with a drying operation. The rinsing and drying operations are often separate processing events. That is, drying typically does not begin until a wafer surface has been rinsed of contaminants and processing chemicals. Drying processes can include one or more of the use of heat, dry gases such as nitrogen, centrifugal force, and even the use of certain drying enhancement materials, e.g., polar organic compounds such as isopropyl alcohol, 1-methoxy-2-propanol, di-acetone alcohol, and ethylglycol. See e.g., U.S. Pat. No. 5,571,337 to Mohindra et al. and U.S. Pat. No. 5,271,774 to Leenaars et al., each of which are fully incorporated herein by reference.

Generally, certain surface properties are desired for microelectronic devices processed in the above described manner. With microelectronic devices and silicon-based devices in particular, it is desirable that the processed wafer(s), after being chemically treated, rinsed, dried, or otherwise processed, exhibits minimal surface particles or contamination, residual electrostatic charge, and water spots, to name a few.

In particular, one generally undesirable phenomena that can result from this type of processing is the buildup of electrostatic charges on a wafer surface. More particularly, it is believed that surface charging can occur because of the relative movement of a processing liquid or gas with respect to a wafer surface. Such charging is generally undesirable because many microelectronics devices can be sensitive to this type of surface condition thus, many industry standards specify acceptable charging characteristics for microelectronics devices. For example, under certain processing conditions, wafers can have surface charging as high as about −12 kV. Certain industry standards, however, require charging to be less than about −0.1 kV and more preferably less than about −0.01 kV, such as for typical CMOS devices and the like. If supported by a current, undue charging levels above desired specifications could damage gate oxide or other device constituents.

Fast, efficient, and economical processing techniques that prevent or minimize wafer surface contamination, electrostatic charging, and water spots that can result from such processing methods are thus desirable. Although the above-described conventional techniques provide processing methods and apparatuses for providing wafers with low surface contamination, improved techniques for controlling charge buildup are desirable. This is especially true for wafer drying processes.

### SUMMARY OF THE INVENTION

The present invention provides methods and systems for processing one or more wafers, especially those with microelectronics devices present in whole or in part on a wafer, that provide improved control of surface charging characteristics of a wafer surface(s) during processing. Such methods and systems advantageously provide the ability to control or limit charging of a wafer surface by using a gaseous antistatic agent at least during a portion of a drying treatment.

In particular, it has been discovered that introducing a gaseous antistatic agent, such as one comprising carbon dioxide gas, into a processing environment (e.g., a vessel, or chamber, or the like) in at least a portion of a drying step, can advantageously control charge buildup during wafer processing. Moreover, performing at least a portion of both a rinsing step and a subsequent drying step in the presence of such a gaseous antistatic agent provides excellent charge buildup control.

Utilizing a gaseous antistatic agent in accordance with the present invention has many benefits. Certain microelectronics devices can be sensitive to electrostatic charging or discharge during the course of manufacture or thereafter; thus, controlling charging effects is often desirable. Also, the principles of the present invention can be easily applied to existing processing systems. Gas distribution devices for providing a gaseous antistatic agent in accordance with the present invention may be formed from simple structures and typically do not require complex gas handling techniques. Indeed, the present invention can be implemented with many existing processing machines with minimal or no modification.

Thus, in accordance with one embodiment of the present invention a method for processing one or more semiconductor wafers in a spray processor is provided. Generally, the method comprises the steps of providing one or more semiconductor wafers in a processing chamber of a spray processor, drying the one or more semiconductor wafers in the processing chamber, and introducing a gas flow into the processing chamber during at least a portion of the drying step wherein the gas flow comprises a gaseous antistatic agent. In one aspect of the present invention the step of drying the one or more semiconductor wafers comprises flowing a drying gas into the processing chamber. For example, the drying gas may comprise gaseous nitrogen. In another aspect of the present invention the gaseous charge reducing agent comprises gaseous carbon dioxide. Also, the gas flow into the processing chamber during at least a portion of the drying step may comprise a carrier gas such as nitrogen gas.

In accordance with another embodiment of the present invention a method for controlling surface charging of semiconductor wafers processed in a spray processor is provided. Generally, the method comprises the steps of providing one or more semiconductors wafers in a processing chamber of a spray processor, performing a processing step and drying step on the one or more semiconductor wafers, and introducing gaseous carbon dioxide into the processing chamber during at least a portion of the drying step. In one aspect of the present invention the step of performing a processing step on the one or more semiconductor wafers comprises a step of rinsing the one or more semiconductor wafers in the processing chamber. In another aspect of the present invention the step of performing a processing step on the one or more semiconductor wafers comprises a step of chemically treating the one or more semiconductor wafers in the processing chamber and may further comprise the step of introducing gaseous carbon dioxide into the processing chamber during at least a portion of the rinsing step.

In accordance with another embodiment of the present invention a method for controlling surface charging of semiconductor wafers processed in a spray processor is provided. Generally, the method comprises the steps of providing one or more semiconductors wafers in a processing chamber of a spray processor, performing a chemical treatment step, a rinsing step, and a drying step on the one or more semiconductor wafers in the processing chamber, and introducing gaseous carbon dioxide into the processing chamber during at least a portion of the rinsing step and at least a portion of the drying steps. In one aspect of the present invention the rinsing step is performed after the chemical treatment step. In another aspect of the present invention the drying step is performed after the rinsing step. Further, in another aspect of the present invention the step of introducing gaseous carbon dioxide into the processing chamber comprises introducing gaseous carbon dioxide into the processing chamber during substantially all of the rinsing step. Also, the step of introducing gaseous carbon dioxide into the processing chamber comprises introducing gaseous carbon dioxide into the processing chamber during substantially all of the drying step.

In accordance with another embodiment of the present invention a method of processing a semiconductor wafer is provided. Generally, the method comprises the steps of providing a semiconductor wafer in a processing chamber of a spray processor, spraying a rinsing fluid onto at least a portion of a surface of the semiconductor wafer and drying at least a portion of the semiconductor wafer. The method further includes performing at least a portion of the spraying and drying steps in an atmosphere comprising a gaseous antistatic agent.

### DETAILED DESCRIPTION

The embodiments of the present invention described below are not intended to be exhaustive or to limit the invention to the precise forms disclosed in the following detailed description. Rather the embodiments are chosen and described so that others may appreciate and understand the principles and practices of the present invention.

The present invention provides methods and systems for the treatment of a wafer, or a plurality of wafers. It has been discovered that use of one or more antistatic agents in accordance with the present invention, especially during at least a portion of a drying step, and more preferably a drying step that follows a rinsing treatment, can provide wafers having reduced residual charging on a wafer surface. In particular, performing both a rinsing and a subsequent drying step in the presence of an antistatic agent provides excellent control over the buildup of residual surface charges.

The use of antistatic agents, preferably gaseous ones, can be particularly advantageous when implemented with conventional processing techniques such as spray processing or the like wherein gas and/or processing liquid flows with respect to a wafer surface. That is, the method of the present invention provides a means by which static charge, induced charge, or other charge effects that can result and buildup during processing can be minimized, substantially eliminated, or otherwise controlled.

For purposes of the present invention, a wafer includes any wafer or object having first and second major, generally oppositely facing, surfaces. Wafers may comprise semiconductor materials, such as silicon and/or gallium arsenide or the like, insulator materials, such as sapphire, quartz, and glass, metallic materials, such as copper for example, or combinations thereof such as silicon-gallium arsenide hybrid wafers. Wafers may further include wafers for hybrid microelectronics manufacture such those formed from ceramics, polymers, composite materials, or the like.

Wafers may include microelectronic devices, partially or fully, formed thereon or may be bare or previously unprocessed wafers. Wafers may also include one or more layers or patterns of material that are used in fabricating microelectronic devices or that will be subsequently formed into componentry of microelectronic devices. Microelectronic devices generally comprise those utilized for forming transistor devices such as thin film transistors, flat-panel displays, MEMS devices, electrical interconnect devices and systems, optical components, components of mass storage devices, and the like. As discussed above in the Background section of the subject application, wafers, especially those including certain microelectronic devices, can be sensitive to certain charging effects, and as such, find particular benefit from processing, rinsing and cleaning, and drying techniques of the present invention.

The principles of the present invention can be applied to many wafer processing technologies that utilize chemical treatment, rinsing, and/or drying processes. These processing technologies generally include any wafer processing technique wherein processing liquids/gases can be delivered to a processing chamber or the like that can position one or more wafers for processing. The present invention can be used in the course of processing single wafers or batches of wafers. That is, any system capable of housing one or more wafers and delivering one or more processing chemicals, liquid, and/or gases sequentially or simultaneously to the one or more wafers may be used to practice the present invention. Advantageously, providing a gaseous antistatic agent in accordance with the methods of the present invention can easily be implemented with such processing technologies with little or no modification to existing, conventionally used equipment such as spray processors, wet benches, or the like.

Generally such processing technologies can be implemented with equipment that is designed and constructed to process one or more wafers through a series of treatments including by way of example one or more of cleaning, etching, rinsing, and/or drying. One type of useful commercially available apparatus is a centrifugal spray-processing apparatus such as one of those available from FSI International, Inc. of Chaska, Minn., e.g., under one or more of the trade designations MERCURY® or ZETA®. These and other commercially available processing equipment may be modified to provide a supply of gaseous antistatic agent as part of desired processing steps such as drying and rinsing steps (preferably both), to perform the methods described herein. Although these specific equipment types can be useful and are specifically mentioned here, the invention is contemplated to be useful in other environments as well, not necessarily requiring any particular design, type, or manufacturer of equipment.

Generally, a typical spray processor apparatus comprises a processing chamber, a rotatable wafer support device, and one or more nozzles for delivering processing chemicals, liquids, and/or gases to the processing chamber such as to one or more wafers positioned on the wafer support device. Usually, plural wafers, such as in a stacked arrangement, are rotated or otherwise moved with respect to the nozzle(s). Such relative movement can be accomplished by movement of the nozzle(s), wafer(s), or both. Single or plural wafers may be processed as desired. Wafers can be processed as a batch, for example. Wafers may be processed while stationary or may be moving relative to the processing apparatus, depending on the process. For example, single wafers may be rotated on a chuck or the like while plural wafers may be similarly rotated for processing by using a cassette or the like to position a stack of wafers accordingly. As an additional example, multiple stacks of wafers may be processed while stationary or may be processed while in motion such as by using a turntable or the like. For certain applications, however, the nozzle(s) may move with respect to the wafers.

A typical spray processor treatment generally comprises one or more chemical steps, one or more rinsing steps, and one or more drying steps. These treatment steps may be performed in various sequences in accordance with various processing recipes that may be tailored to achieve a desired result.

A rinsing step generally comprises rinsing one or more wafers with a rinsing fluid. The rinsing fluid can be any fluid, especially a liquid, that can be applied to a wafer surface, generally as a flow across the surface, and which can be dried to leave a substantially residue free surface. Such rinsing fluids are generally known in the art of processing microelectronic devices, and often comprise water, especially ultrapure, deionized water, sometimes with small amounts of various water miscible additives or processing aids, such as surfactants (e.g. a hydrocarbon surfactant), dissolved carbon dioxide, ozone, hydrogen peroxide, or the like. The rinsing fluid may also contain, for example, desired amounts of acid such as HCl, HF; -buffered HF (BOE), or H₂SO₄; or a base such as ammonium hydroxide.

The rinsing fluid may be at any useful temperature, and may optionally be chilled, at ambient, or heated, depending on factors including the wafer(s) characteristics, rinsing fluid, recipe, etc. A general temperature range for an aqueous rinsing fluid can be from about 0° C. to 95° C. Elevated temperatures are attractive because they can often allow faster rinsing action in that a rinsing fluid at an elevated temperature may be more effective in dissolving or removing materials from a surface, and an effective rinsing step can take a shorter time. For wafers that are temperature stable, temperatures in the range from about 40° C. to 95° C. may be preferred. On the other hand, some wafers might include temperature sensitive constituents. For these wafers, the rinsing fluid temperature may preferably be somewhere in the range from about 5° C. to 40° C.

The flow rate of the rinsing fluid can be any that is effective, and can be optimized to provide a useful rinse of wafer surface(s). Flow rate can be chosen based on factors including, but not limited to, the identity and properties of the rinsing fluid, the materials to be rinsed from the surface, and the timing (e.g., duration) of the rinse.

The time required to accomplish an effective rinse can depend on various factors including the identity and properties of the wafer(s) and the rinsing fluid(s), the identity and amount of materials to be rinsed from the surface, the flow rate, and temperature of the rinsing fluid, etc. In general, a rinse can last in the range of a few seconds to several minutes, for example, preferably from about 5 seconds to about 30 minutes.

The rinsing fluid can be applied to a wafer surface(s) in any desired fashion, e.g., directed at the wafer(s) at any suitable pressure, velocity, and orientation that will cause rinsing. The rinsing fluid can be in the form of a continuous liquid stream, a pulsed or interrupted stream, or a spray, and any such rinsing fluid may be moving across a wafer surface. The wafer(s) may be oriented vertically, horizontally, or otherwise. The rinsing fluid may be introduced into the processing chamber in any desired manner, for example, the rinsing fluid may be introduced such that it is delivered at any angle to or position on the surface, e.g., near an edge or center, in a direction almost parallel to a surface from a position perpendicular to a surface, or otherwise.

Typically, a drying step comprises providing a flow of drying gas such as nitrogen gas and/or other desired drying gas to the wafer(s) to remove any remaining rinsing liquid. A drying gas may be heated if desired. Drying also can incorporate motion of a wafer(s), e.g., spinning or rotating using a centrifuge or turntable. Wafers can be rotated at one speed or a modified drying process can be used. In a modified drying process, the speed of rotation of a wafer is reduced for at least one portion of the process. In one exemplary process a wafer may be rotated at a first speed for a predetermined period of time and then accelerated to a second higher speed for a predetermined time. The wafer speed may then be reduced to another speed, which may be the same as the first speed, for a predetermined period of time or the wafer may be brought to rest. Such a modified dry process may provide less surface charging (as compared to a standard drying process) because the rate of rinsing fluid removal from the wafer surface is limited.

Drying can also incorporate exposure to energy or elevated temperature; exposure to drying enhancement materials, e.g., an alcohol (e.g., isopropyl alcohol) as might be used in so-called Marangoni drying; a combination of these or the like. The use of such materials in Marangoni style drying processes is described, for example, in U.S. Pat. No. 5,571,337 to Mohindra et al. and U.S. Pat. No. 5,271,774 to Leenaars et al., both of which are fully incorporated herein by reference in their entireties. In one exemplary embodiment, a gaseous drying enhancement agent may be isopropyl alcohol vapor at a concentration in the range from about 1 to about 6 volume percent in nitrogen.

In accordance with the present invention, at least a portion of a drying step preferably takes place in the presence of an antistatic agent for controlling charge buildup on wafer surfaces during such processing. More preferably, an antistatic agent is introduced into the process chamber during at least a portion of a rinsing step, and then an antistatic agent (which may be the same or different than that used in rinsing) is introduced into the processing chamber during at least a portion of a drying step. When introduced during drying, the antistatic agent can be introduced into the process chamber as all or a portion of a drying gas composition. When more than one such gas is used, the gaseous antistatic agent may be pre-mixed with other gas(es) and then introduced into the chamber. Alternatively, the gaseous antistatic agent can be introduced into the process chamber separately from one or more other gas(es).

If introduced during rinsing, the antistatic agent may be introduced as a constituent of the rinsing fluid (e.g., as dissolved CO₂ in a preferred embodiment) and/or introduced as a gas constituent (e.g., CO₂ gas preferably) of a gas composition separately from the rinsing fluid. The process chamber of the rinsing (if any) and drying steps may be the same or different.

It is contemplated that any antistatic agent may be used so long as it is sufficiently compatible with the wafer(s) and/or other processing gases or liquids utilized. A wide range of antistatic agents may be used in the present invention. For drying, the antistatic agent generally is preferably a gas under the applicable drying conditions. Because of its wide availability, low cost, ease of incorporation into many manufacturing designs and lack of any safety or handling issues, carbon dioxide is presently preferred for use as at least a portion of, and preferably at least substantially all of the gaseous antistatic agent in the methods of the present invention. Others include ionized dry air, ionized nitrogen or any gases that can be easily ionized. For rinsing these same gaseous antistatic agents may be used either as solute or may be separately introduced. Additionally, liquid or water-soluble, solid antistatic agents may be dissolved in the rinsing fluid.

Generally, whether a gas or ionized gas will be considered to be an antistatic agent can be determined empirically in a number of different ways. According to one approach, one or more wafers are processed in a MERCURY® tool according to a process recipe comprising at least one rinse step and at least one dry step. In a first run, the gas under consideration is not introduced into the process chamber in any rinse or drying step. Charge buildup, C1, on the wafer(s) at the end of the recipe is then measured and an average is determined. Meanwhile, in a second run, the same process is carried out except that the gas under consideration is introduced into the process chamber during the entirety of all rinse and dry steps. To carry out the test, the candidate gas is introduced into the chamber in admixture with N₂ carrier gas at a concentration such that the weight ratio of the carrier gas to candidate gas is about 60:1. Charge build up, C2, on the wafer(s) at the end of the recipe is then measured and an average is determined. The candidate gas will be deemed to be an antistatic agent if the ratio given by C1/C2 (average values) is less than about 0.25, more preferably less than about 0.1, and more preferably less than about 0.01. More preferably, a gas will be deemed to be an antistatic agent if the average value of C2 is less than about −1.0 kV, more preferably less than about −0.1 kV.

Under this preferred definition, neither nitrogen nor ionized nitrogen is an antistatic agent, whereas each of ionized clean dry air, non-ionized carbon dioxide, and ionized carbon is an antistatic agent. For instance, nitrogen gas per se has de minimis ability to control charging. Ionized nitrogen is not much better than non-ionized nitrogen. In a representative experiment, using ionized nitrogen limited charging only from about −12 kV down to about −7 kV to about −8 kV. This reduction is not enough to meet more stringent industry standards, where charging is specified to be less than −0.1 kV, more preferably less than about −0.01 kV. If supported by a current, undue charging levels above desired specifications can ruin a device such as by damaging gate oxide or other device constituents. Nonetheless, it remains an option to use an ionizer in the practice of the present invention to ionize all or a portion of any nitrogen gas that is introduced. e.g., as a carrier gas, into the process chamber during drying, rinsing, chemical treatment, or the like.

Additionally, the use of an ionizer can convert an otherwise conventional gas into an effective gaseous antistatic agent. For instance, using clean dry air by itself generally provides too little protection against charge build up for clean dry air to be considered to be an antistatic agent. However, ionized clean dry air is an effective antistatic agent that can limit charging levels to below about −0.1 kV.

Some gases are extremely effective antistatic agents even without ionizing. For instance, it has been discovered that carbon dioxide is surprisingly able to limit charging to such a great degree even without being ionized, the use of an ionizer provides very little if any extra benefit when carbon dioxide is used. Specifically, carbon dioxide is easily capable of limiting charging to levels as low as −0.01 kV or even less without ionization.

Consequently, the process of the invention can have particularly advantageous benefits in the manufacture of complementary metal-oxide semiconductor (CMOS), wafer devices with thin gate oxides, shallow junction, EEPROM, and the like, which can be particularly sensitive to electrostatic charging that might otherwise build up if not effectively limited. The present invention finds utility in the context of carrying out the so-called “critical clean” of gate oxide, wherein the wafer surface typically comprises oxide and bare silicon.

In the practice of the present invention, charge build up on a wafer can be measured in accordance with standard industry practices. In a preferred mode of practice, wafer charging can be measured by a non-contact, non-destructive mode. Commonly, there are three steps involved. A corona discharge is used to bias the wafer surface and emulate the function of the metal oxide semiconductor electrical contact. A vibrating Kelvin probe is used to monitor the entire wafer potential as a function of the wafer charge. Finally, a pulsed light source linked to the Kelvin probe enables the stimulus and detection of surface photo-voltage (SPV), which, in turn, provides additional information on the silicon electronic energy level band bending. The SPV curves are used to calculate and extract the system's electrical test parameters. The test results are presented as “maps” or “fingerprints” to provide a quick overview of the charge distribution. There are several commercially available tools for measuring the surface static charges. For example, QUANTOX by KLA-Tencor and FAaST 230 by Semiconductor Diagnostics Inc. may be used.

Another method to measure the surface charge is to use CHARM wafers provided by Wafer Charging Monitors, Inc. These are wafers contain specialized EEPROM-based sensors that measure surface charging during the actual wafer processing step. The CHARM wafers are placed in the process chamber to go through the actual wafer processing step that is being investigated and the specialized EEPROM-based sensors are measured after the processing step to determine the amount of charging that occurred.

In accordance with the present invention, at least a portion of a drying step preferably takes place in the presence of an antistatic agent. More preferably, at least respective portions of both a rinsing step and a subsequent drying step take place in the presence of antistatic agent(s). In particular, it has been discovered that using antistatic agents during at least a portion of a drying step or both a rinsing and drying step, helps to dramatically minimize or even substantially eliminate charge buildup on wafer surfaces. The antistatic agent used during any rinse(s) or drying step(s) may be the same or different.

A typical process recipe may incorporate one or more rinses and one or more drying steps of which the following recipe is typical:

Chemical Treatment 1
Rinse

Chemical Treatment 2
Rinse

Chemical Treatment 3
Rinse
Final rinse
Dry

While not wishing to be bound by theory, it is presently believed that the relative movement between rinse water and the wafer(s) is one significant factor that causes charging. In particular, static and induced charging can rapidly accumulate in environments involving moving water contacting moving polymer components of process tooling. Further, once charge has built up to some level, it can be difficult to remove. Accordingly, preferred modes of practice involve using antistatic agents not just in the drying step(s) of a recipe, but also during the course of at least one, and preferably all, rinses of a recipe. It has been found that this more thorough, preferred practice produces wafers that are more charge neutral than if any portion of rinsing occurs in the absence of antistatic agent(s).

When the antistatic agent is introduced into a process chamber as a gas, such as occurs in a drying step and optionally in a rinsing step, the gaseous antistatic agent is preferably present at a concentration effective to achieve desired charge control and can be determined empirically for a particular process. Surprisingly small amounts are effective to help control charging. Yet, the agent may also constitute up to 100% of gas introduced into a process chamber. However, a typical antistatic agent, such as carbon dioxide, tends to be more expensive than a conventional carrier gas such as nitrogen. Additionally, above a certain concentration, using additional antistatic agent may tend to provide little if any extra performance benefit.

Balancing such concerns, therefore, it is preferred for practical reasons to introduce the antistatic agent into a process chamber along with a carrier or diluent gas. The relative amounts of carrier gas and antistatic agent can vary over a wide range. Generally, suitable embodiments would include 0.001 to 100, preferably 0.01 to 50, more preferably 0.1 to 20 weight percent of gaseous antistatic agent(s) based upon the total weight of carrier gas(es) and antistatic agent(s). In a specific context of practicing the present invention in a MERCURY® tool, a preferred mode of practice involves using about 1 to about 300 standard cubic feet per hour of antistatic agent such as carbon dioxide per about 1 to about 50 standard cubic feet per minute of carrier gas such as nitrogen.

Any carrier gas may be used, including, but not limited to nitrogen, argon, clean dry air, combinations of these, and the like. Of these, nitrogen and clean dry air are preferred. Nitrogen is more preferred when an inert processing environment is desired.

As with any processing fluids such as rinse water drying gas, etc., certain purity considerations can be involved when the gaseous antistatic agent is contacted with certain wafers. For example, as will be understood by those skilled in processing microelectronic devices, high purity gaseous antistatic agent should be used to minimize the number of particles that will be present on a surface of a device at the end of processing.

During a drying or rinsing process including introduction of an antistatic agent, the wafer(s) may be oriented vertically, horizontally, or otherwise. In modes of practice in which the antistatic agent is a gas, the agent may be introduced into the process chamber in any desired fashion. For instance, the agent may be introduced generally toward the wafer(s) or otherwise.

It is a distinct advantage of the invention that the charge control benefits of the invention are achieved over a wide temperature range, including temperatures cooler than ambient, at ambient, or hotter than ambient. In other words, excellent charge control is achieved regardless of temperature within the temperature range likely to be encountered when carrying out drying and rinsing operations. Thus, the use of antistatic agent need not alter the temperature at which a drying or rinsing operation otherwise is desirably carried out, and drying and rinsing may be carried out under desired temperature conditions in accordance with conventional practices.

It is noted that using a gaseous antistatic agent for minimizing or eliminating charge buildup can advantageously result in very uniform charge reduction of a wafer surface and among different wafers, which is especially important when a plurality of wafers are processed.

The present invention will now be further described with reference to the following examples.

Wafer processing experiments were performed on 200 mm diameter silicon wafers in an FSI ZETA® spray processing system. The wafers had a 1000 angstrom oxide film grown on a surface of the wafers in a furnace by thermal oxidation using oxygen and hydrogen. Before thermal oxidation, the wafers were pre-cleaned by immersion processing in an FSI Magellan system using SPM (sulfiric peroxide mix) and APM (ammonia peroxide mix) to remove surface contaminations such as organic films and particle defects.

In these experiments, cassettes were loaded with 25 wafers and loaded into the processing system. The recipe used for processing the wafers is set forth in Table 1. As shown in Table 1, the wafers were first processed with an SPM treatment in which the wafers were exposed to approximately 250 cc per minute of 30% H₂O₂ mixed with 800 cc per minute of 96% H₂SO₄ (ratio equals 1:3.2) for 635 seconds. Turntable speeds of 20 rpm, 350 rpm, and 200 rpm were used for the time intervals shown in Table 1. Also, N₂ gas was provided at about 75 to 90 psi and at room temperature. The N₂ gas flow rate was 22 CFH for this treatment.

Next, the wafers were rinsed in a first rinse treatment with DI water for 156 seconds. The DI water was delivered at 2000 cc/min and at 70 degrees C. and 80 degrees C. for the time intervals shown in Table 1. The turntable speeds in this first rinse treatment were 20 rpm, 60 rpm, and 500 rpm for the time intervals shown in Table 1. During this first rinse treatment, CO₂ gas was provided to the processing chamber of the system from a compressed gas cylinder at 45 psi and at room temperature. The flow of the CO₂ gas was controlled by a flow meter. The CO₂ gas was delivered through the center and side bowl spray posts. Experiments were conducted for CO₂ flow rates, in CFH, of 0, 25, 35, 100, 200, and, 300, respectively, as can be seen in Table 2, which is discussed below. Also, N₂ gas was used to atomize the rinse water and was delivered through the center and side bowl spray posts. The N₂ gas was provided to the system at about 75 to 90 psi and at room temperature. The flow rates for N₂ for this rinse treatment were 22 CFH and 28 CFH for the time intervals shown in Table 1.

Next, the wafers were processed with an APM treatment. As can be seen in Table 1, the APM treatment was performed for a total of 360 seconds. The chemical flows for the APM treatment were 240 cc per minute of 30% H₂O₂, 30 cc per minute of 35% NH₄OH and 1920 cc per minute of DI water at 70 degrees C. The turntable rotational speeds used during this treatment were 60 rpm and 500 rpm for the time intervals shown in Table 1. During the APM treatment, room temperature N₂ gas was used to atomize the chemicals and a flow rate of 13 CFH was used.

The final rinse and dry steps were performed as shown in Table 1 and involved 336 seconds of 90 degree C. DI water rinse and 510 seconds of N₂ dry respectfully. CO₂ gas was introduced during the entire 746 seconds of the rinse and final dry. The N₂ gas was used at flow rates, in CFH, of 13, 22, 28, and 74 for the time intervals shown in Table 1.

After the final dry treatment, the processed wafers were removed from the spray system and measured with an SDI FAaST 230 tool (Semiconductor Diagnostics Inc.) to determine the surface charge. A non-processed silicon wafer with a 1000 angstrom thick thermal oxide layer was used as a reference wafer and was measured with the FAaST 230 as a baseline for comparison. These results are summarized in Table 2 for the various CO₂ flow rates used. The measured surface charge is displayed in terms of voltage normalized by the thickness of the oxide, which is 1000 angstroms. Table 2 also shows the final surface charge as a function of the CO₂ flow rate in cubic feet per hour (CFH) into the process chamber.

It is noted that if the CO₂ was introduced only in the final rinse and final dry treatments during the process (i.e., no CO₂ flow during the rinse in-between the SPM and APM steps) the wafers generally showed slightly higher charging than the wafers processed with CO₂ in all rinse and dry treatments. Our data showed that using 100 CFH of CO₂ only in the final rinse and final dry treatments, wafers had about −2.05 volts of charge as compared to −0.24 volts in Table 2 where CO₂ was used in the rinse treatment between the SPM and APM steps (all the rinse and dry treatments). That is, use of CO₂ is beneficial in the final rinse and dry treatments and even lower charging can be obtained is CO₂ if used in all of the rinse and dry treatments.

Ionized gases can be used to remove surface charges. The amount of ions generated to neutralize the charges is determined by the power of the ionizer, environmental humidity, and gas impurity. N₂ and CDA have been used widely in this application as antistatic agents. Additionally, non-ionized CO₂ gas which can be dissolved in DI water to has also been use to reduce static charging on wafer. In the dissolved CO₂ case, the solubility of the CO₂ in the DI water is a crucial parameter. Since the amount of the CO₂ carried to wafers to perform the job is limited by the amount of CO₂ dissolved in the DI water, thus environmental factors become very important in using the dissolved CO₂.

The current invention, however, does not have those restrictions. The non-ionized and/or ionized CO₂ is introduced with N₂ gas. N₂ and CO₂ mix very well together. From Table 2, it can be seen that significant surface charge reduction can be realized with CO₂ flow rates even below 25 CFH.

We have also carried out tests using ionized N₂ gas, ionized compressed dry air (CDA) and ionized CO₂ as a comparison. This used the same setup as the non-ionized CO₂ tests described above. These tests were performed in an FSI MERCURY® system by using a process recipe similar to that shown in Table 1. The conditions for chemicals, N₂, DI water and CO₂ flows are also similar to those used in the ZETA® system described above. In addition, an in-line gas ionizer, ION system Model 4210, was used before the gas enters the spray system. The results of these experiments for a CO₂ flow rate of 100 CFH are shown in Table 3.

Table 3 suggests that, with ionized ions, CO₂ is better than N₂ or CDA to control the surface charging. Comparing Table 3 to Table 2, we can see that 300 CFH of CO₂ without ionization is as effective at eliminating the surface charging as 100 CFH of CO₂ with ionization. It is surprising that non-ionized CO₂ gas should have this neutralizing effect. Using non-ionized CO₂ is more cost effective and avoids potential contamination associated with the ionizing apparatus.

Numerous characteristics and advantages of the invention meant to be described by this document have been set forth in the foregoing description. It is to be understood, however, that while particular forms or embodiments of the invention have been illustrated, various modifications can be made without departing from the spirit and scope of the invention.

TABLE 1
Recipe steps for SPM-rinse-APM-final rinse-final dry

| | | | | N2 | | | | |
|---|---|---|---|---|---|---|---|---|
| SPM | | | | (room | | | DIW | |
| Time | Sulfuric | | | temp. | CO2 | DIW | Temp | Speed |
| (Sec) | (cc/min) | Peroxide | Ammonia | CFH) | (room temp.) | (cc/min) | (C.) | (rpm) |
| 30 | 800 | 250 | | 22 | | | 95 | 20 |
| 450 | 800 | 250 | | 22 | | | 95 | 20 |
| 150 | 800 | 250 | | 22 | | | 95 | 350 |
| 5 | 800 | 250 | | 22 | | | 95 | 200 |
| Rinse | | | | | | | | |
| 32 | | | | 22 | On | 2000 | 80 | 500 |
| 42 | | | | 28 | On | 2000 | 80 | 60 |
| 30 | | | | 28 | On | 2000 | 80 | 20 |
| 16 | | | | 22 | On | 2000 | 70 | 500 |
| 21 | | | | 28 | On | 2000 | 70 | 60 |
| 15 | | | | 28 | On | 2000 | 70 | 20 |
| APM | | | | | | | | |
| 225 | | 240 | 30 | 13 | | 1920 | 70 | 60 |
| 60 | | 240 | 30 | 13 | | 1920 | 70 | 500 |
| 60 | | 240 | 30 | 13 | | 1920 | 70 | 60 |
| 15 | | 240 | 30 | 13 | | 1920 | 70 | 500 |
| Final | | | | | | | | |
| Rinse | | | | | | | | |
| 32 | | | | 22 | On | 2000 | 90 | 500 |
| 42 | | | | 28 | On | 2000 | 90 | 60 |
| 30 | | | | 28 | On | 2000 | 90 | 20 |
| 16 | | | | 22 | On | 2000 | 90 | 500 |
| 21 | | | | 28 | On | 2000 | 90 | 60 |
| 15 | | | | 28 | On | 2000 | 90 | 20 |
| 15 | | | | 22 | On | 2000 | 90 | 500 |
| 20 | | | | 28 | On | 2000 | 90 | 180 |
| 20 | | | | 28 | On | 2000 | 90 | 60 |
| 30 | | | | 13 | On | 2000 | 90 | 500 |
| 60 | | | | 74 | On | 2000 | 90 | 180 |
| Final | | | | | | | | |
| Dry | | | | | | | | |
| 120 | | | | 80 | On | | | 500 |
| 390 | | | | 51 | On | | | 500 |

TABLE 2
Surface Charge using CO₂ during rinse and final rinse and final dry steps.

| CO2 flow Rate | | | | | | | |
|---|---|---|---|---|---|---|---|
| (CFH) | 0 | 25 | 35 | 100 | 200 | 300 | Ref. |
| Ave. Wafer | −9.99 | −0.73 | −0.44 | −0.24 | −0.16 | −0.069 | −0.029 |
| Charge (V) | | | | | | | |

TABLE 3
Surface charge results using CO₂, N₂ and CDA with 100 CHF flow rate.

| Antistatic gas | Ion. CO2 | Ion. N2 | Ion. CDA |
|---|---|---|---|
| Ave. Wafer Charge (V) | −0.07 | −8.36 | −4.47 |

1. A method for processing one or more semiconductor wafers, the method comprising the steps of:
providing one or more semiconductor wafers in a processing chamber; and
drying the one or more semiconductor wafers in the processing chamber wherein during at least a portion of the drying step the one or more semiconductor wafers are in the presence of an antistatic agent.

2. The method of claim 1, wherein the step of drying the one or more semiconductor wafers comprises flowing a drying gas into the processing chamber.

3. The method of claim 2, wherein the drying gas comprises gaseous nitrogen.

4. The method of claim 1, wherein the antistatic agent comprises carbon dioxide.

5. The method of claim 1, wherein the antistatic agent comprises ionized clean dry air.

6. The method of claim 1, wherein the step of drying the one or more semiconductor wafers comprises introducing a drying enhancement substance into the processing chamber.

7. The method of claim 6, wherein the drying enhancement substance comprises isopropyl alcohol.

8. The method of claim 1, further comprising performing at least one additional processing step on the at least one or more semiconductor wafers in the processing chamber.

9. The method of claim 8, wherein the at least one additional processing step comprises a rinsing step that precedes the drying step.

10. The method of claim 9, wherein at least a portion of the rinsing step occurs in the presence of an antistatic agent.

11. The method of claim 10, wherein the antistatic agent comprises a gaseous antistatic agent.

12. The method of claim 10, wherein the antistatic agent comprises solute in a rinsing fluid.

13. The method of claim 10, wherein the gaseous antistatic agent present during at least a portion of the rinsing step comprises carbon dioxide.

14. The method of claim 10, wherein the gaseous antistatic agent present during at least a portion of the rinsing step comprises ionized clean dry air.

15. A method for controlling surface charging of semiconductor wafers, the method comprising the steps of:
providing one or more semiconductors wafers in a processing chamber;
performing a processing step on the one or more semiconductor wafers in the processing chamber;
performing a drying step on the one or more semiconductor wafers in the processing chamber; and
introducing gaseous carbon dioxide into the processing chamber during at least a portion of the drying step.

16. The method of claim 15, wherein the step of performing a processing step on the one or more semiconductor wafers comprises a step of rinsing the one or more semiconductor wafers in the processing chamber.

17. The method of claim 16, further comprising the step of introducing gaseous carbon dioxide into the processing chamber during at least a portion of the rinsing step.

18. The method of claim 15, wherein the step of introducing gaseous carbon monoxide comprises further comprises introducing a carrier gas.

19. The method of claim 18, wherein the carrier gas comprises nitrogen.

20. A method for controlling surface charging of semiconductor wafers processed in a spray processor, the method comprising the steps of:
providing one or more semiconductors wafers in a processing chamber of a spray processor;
performing a chemical treatment step on the one or more semiconductor wafers in the processing chamber;
performing a rinsing step on the one or more semiconductor wafers in the processing chamber;
performing a drying step on the one or more semiconductor wafers in the processing chamber; and
introducing gaseous carbon dioxide into the processing chamber during at least a portion of the rinsing step and at least a portion of the drying steps.

21. The method of claim 20, wherein the rinsing step is performed after the chemical treatment step.

22. The method of claim 20, wherein the drying step is performed after the rinsing step.

23. The method of claim 20, wherein the step of introducing gaseous carbon dioxide into the processing chamber comprises introducing gaseous carbon dioxide into the processing chamber during substantially all of the rinsing step.

24. The method of claim 20, wherein the step of introducing gaseous carbon dioxide into the processing chamber comprises introducing gaseous carbon dioxide into the processing chamber during substantially all of the drying step.

25. A method of processing a semiconductor wafer, the method comprising:
providing a semiconductors wafer in a processing chamber of a spray processor;
spraying a rinsing fluid onto at least a portion of a surface of the semiconductor wafer in an atmosphere comprising a gaseous antistatic agent; and
drying at least a portion of the semiconductor wafer in an atmosphere comprising a gaseous antistatic agent.
